(19) United States
(12) Patent Application Publication
(10) Pub. No.: US 2014/0218674 A1
(43) Pub. Date: Aug. 7, 2014

(54) LIQUID CRYSTALLINE POLYMER LENS STRUCTURE

(71) Applicant: LIQXTAL TECHNOLOGY INC., TAINAN CITY (TW)

(72) Inventors: HUNG-SHAN CHEN, Taichung City (TW); YI-HSIN LIN, Zhubei City (TW)

(73) Assignee: LIQXTAL TECHNOLOGY INC., TAINAN CITY (TW)

(21) Appl. No.: 13/828,723

(22) Filed: Mar. 14, 2013

(30) Foreign Application Priority Data
Feb. 7, 2013 (TW) 102104728

(51) Int. Cl. G02B 3/12

(52) U.S. Cl. CPC G02B 3/12
USPC 349/200

(57) ABSTRACT

A liquid crystalline polymer lens structure includes a refractive index distribution film, a lens and a flexible substrate. The flexible substrate is laminated on the surface of the lens, and the refractive index distribution film is encapsulated inside the flexible substrate. The refractive index distribution film has a non-uniform refractive index distribution, and can design to make the liquid crystalline polymer lens structure have multi-segment or gradual variation of optical power, so as to improve the presbyopia's reading ability.

### CROSS-REFERENCE TO RELATED APPLICATION

This application claims the benefit of Taiwan Patent Application No. 102104728, filed on Feb. 7, 2013, in the Taiwan Intellectual Property Office, the disclosure of which is incorporated herein in its entirety by reference.

### FIELD OF THE INVENTION

The present invention relates to a liquid crystalline polymer lens structure, and more particularly to the liquid crystalline polymer lens structure having a refractive index distribution film with a non-uniform refractive index distribution.

### BACKGROUND OF THE INVENTION

In general, the principle of designing a lens is to let a traveling light produce an optical path difference (thickness*refractive-index). Since the conventional spherical lens has a thickness increases with the optical power, therefore an improved method uses a Fresnel lens to divide the thickness into a smaller periodical structure was proposed. But the manufacture of the mold for the Fresnel lens is very difficult, and the optical performance has the issues of a high chromatic dispersion and low diffraction efficiency. Therefore, conventional flat lenses such as glasses lenses achieve a change of the optical path difference by changing the refractive index distribution.

Wherein, the liquid crystalline polymer has the unique birefringence feature, and thus it can be used for the design of a flat lens. Since the liquid crystalline polymer also has the properties of dielectric anisotropy, therefore the electric field distribution can be applied to manufacture an electrically tunable liquid crystal lens. However, the present liquid crystalline polymer film only has the same refractive index distribution. In other words, each position of the liquid crystalline polymer film has the same focal length. Therefore, the present liquid crystalline polymer film with the design of a single focal length cannot be used freely with other lens. Due to the liquid crystalline polymer film having the design of a single focal length, additional components are required to change the refractive index distribution of the liquid crystal lens for manufacturing the electrically controlled liquid crystal lens.

### SUMMARY OF THE INVENTION

In light of the issues raised in prior art, a primary objective of the present invention is to provide a liquid crystalline polymer lens structure having a birefringence and a non-uniform refractive index distribution.

To achieve the aforementioned objective, the present invention provides a liquid crystalline polymer lens structure, including a flexible substrate, a first lens and a first refractive index distribution film. The flexible substrate is laminated on the first surface of the first lens. The first refractive index distribution film is composed of a liquid crystal and a liquid crystalline polymer and encapsulated inside the flexible substrate, and the first refractive index distribution film has a first refractive index layer parallel to a first direction of the first surface, and a second refractive index layer parallel to a second direction of the first surface, and the first direction is different from the second direction, wherein the first refractive index and the second refractive index have a non-uniform refractive index distribution in the first direction and the second direction respectively.

Preferably, the liquid crystalline polymer lens structure may further include a second refractive index distribution film composed of a liquid crystal and a liquid crystalline polymer, and encapsulated inside the flexible substrate, wherein the second refractive index distribution film has a third refractive index parallel to the first direction of the first surface and a fourth refractive index parallel to the second direction of the first surface, and the first refractive index distribution film has an optical axis in the first direction, and the second refractive index distribution film has an optical axis in the second direction.

Preferably, the liquid crystalline polymer lens structure may further include a second lens having a second surface opposite to the first surface, and the flexible substrate is laminated between the first surface and the second surface.

Preferably, the third refractive index and the fourth refractive index may have a non-uniform refractive index distribution in the first direction and the second direction respectively.

Preferably, the flexible substrate may be a laminating film or a flexible plastic substrate.

To achieve another objective, the present invention further provides a liquid crystalline polymer lens structure including a first lens, a second lens, a first electrode layer, a second electrode layer and a composite layer. The first lens has a first surface, and the second lens has a second surface facing the first surface. The first electrode layer is disposed on the first surface of the first lens, and the second electrode layer is disposed on the second surface of the second lens, and the composite layer is disposed between the first electrode layer and the second electrode layer, and the composite layer, arranged in a direction from the first electrode layer to the second electrode layer, sequentially comprises: a first alignment layer disposed on the first electrode layer; a first liquid crystal layer disposed on the first alignment layer; and a first refractive index distribution film composed of a liquid crystal and a liquid crystalline polymer and disposed on the first liquid crystal layer and having a birefringence with a non-uniform refractive index distribution.

Preferably, the composite layer, along the direction from the first electrode layer to the second electrode layer, may further sequentially include a second refractive index distribution film, a second liquid crystal layer and a second alignment layer. The second refractive index distribution film is composed of a liquid crystal and a liquid crystalline polymer and disposed on the first refractive index distribution film, and the second refractive index distribution film has the features of a birefringence and a non-uniform refractive index distribution. The second liquid crystal layer is disposed on the second refractive index distribution film, and the second alignment layer is disposed on the second liquid crystal layer. Wherein, the alignment direction of the first liquid crystal layer is different from the alignment direction of the second liquid crystal layer, and the alignment direction of the first refractive index distribution film is different from the alignment direction of the second refractive index distribution film.

Preferably, the liquid crystalline polymer lens structure may further include a polarizer installed on the other side of the first surface of the first lens.

Preferably, the first liquid crystal layer may be aligned with an anti-parallel alignment, a vertical alignment, a hybrid alignment or a twisted nematic alignment.

To achieve a further objective, the present invention further provides a liquid crystalline polymer lens structure comprising a refractive index distribution film, a polarizer and a polarization controller. The refractive index distribution film is composed of a liquid crystal and a liquid crystalline polymer, and the refractive index distribution film features a birefringence and a non-uniform refractive index distribution. The polarizer is installed on a side of the refractive index distribution film, and the polarization controller is installed between the polarizer and the refractive index distribution film. Wherein, the polarization controller changes the polarization direction of the polarized light passing through the polarizer.

In summation, the liquid crystalline polymer lens structure of the present invention has one or more of the following advantages:

(1) The liquid crystalline polymer film of the present invention is flexible, so that it can be used together with the lens as a simple lens sticker.

(2) The liquid crystalline polymer film of the present invention with a non-uniform refractive index distribution has the effect of correcting nearsightedness, farsightedness, presbyopia and parallax.

(3) The liquid crystalline polymer film of the present invention with a non-uniform refractive index distribution can change the refractive index distribution of the liquid crystalline polymer lens structure without requiring additional components for its application in the electrically controlled liquid crystal lens.

### BRIEF DESCRIPTION OF THE DRAWINGS

FIG. 1 is a schematic view of a refractive index distribution film of the present invention.

FIG. 2 is a first schematic view of a method of manufacturing a refractive index distribution film in accordance with a preferred embodiment of the present invention.

FIG. 3 is a second schematic view of a method of manufacturing a refractive index distribution film in accordance with a preferred embodiment of the present invention.

FIG. 4 is a first schematic view of a method of manufacturing a refractive index distribution film in accordance with another preferred embodiment of the present invention.

FIG. 5 is a second schematic view of a method of manufacturing a refractive index distribution film in accordance with a first preferred embodiment of the present invention.

FIG. 6 is a schematic view of a liquid crystalline polymer lens structure in accordance with a second preferred embodiment of the present invention.

FIG. 7 is a schematic view of a liquid crystalline polymer lens structure in accordance with a third preferred embodiment of the present invention.

FIG. 8 is a first schematic view showing the lens effect of a liquid crystalline polymer lens structure in accordance with the third preferred embodiment of the present invention.

FIG. 9 is a second schematic view showing the lens effect of a liquid crystalline polymer lens structure in accordance with the third preferred embodiment of the present invention.

FIG. 10 is a schematic view of a liquid crystalline polymer lens structure in accordance with a fourth preferred embodiment of the present invention.

FIG. 11 is a schematic view of a liquid crystalline polymer lens structure in accordance with a fifth preferred embodiment of the present invention.

FIG. 12 is a schematic view of a liquid crystalline polymer lens structure in accordance with a sixth preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

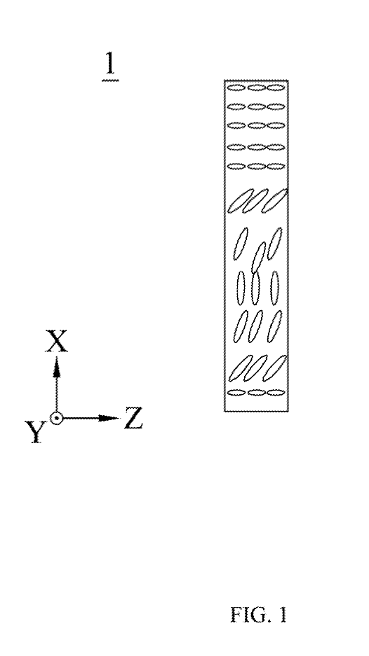

With reference to FIG. 1 for a schematic view of a refractive index distribution film of the present invention, the refractive index distribution film 1 comprises a liquid crystalline molecule and a liquid crystalline polymer. In present embodiment, the refractive index distribution film 1 has an optical axis in a direction of the X-direction. In other embodiments of the present invention, the optical axis of the refractive index distribution film 1 can be in a direction of the Y-direction. The refractive index distribution film 1 of the present invention is made of a liquid crystalline polymer, so that it has the property of birefringence. In other words, the refractive index of incident lights having different polarizations and passing through the refractive index distribution film 1 varies. For example, when a light passes through the refractive index distribution film 1, the polarized light with a polarization direction in X-direction and the polarized light with a polarization direction in Y-direction have different focuses.

It is noteworthy that the refractive index distribution film 1 of present embodiment has a symmetric refractive index distribution in the XY-direction, and the refractive index distribution film 1 in other embodiments of the present embodiment may have an asymmetric refractive index distribution. For better understanding, the manufacturing method of a refractive index distribution film in accordance with embodiments of the present invention is described below.

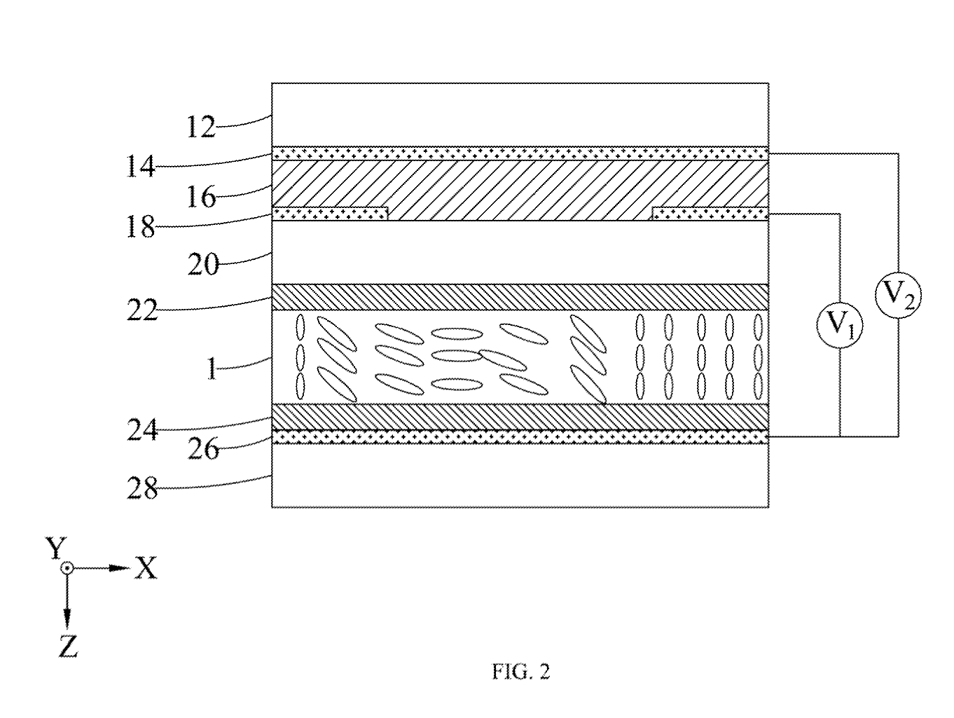

With reference to FIG. 2 for a first schematic view of a method of manufacturing a refractive index distribution film in accordance with a preferred embodiment of the present invention, a two-voltage structure providing a non-uniform voltage distribution is adopted in this preferred embodiment to manufacture a refractive index distribution film 1 with a refractive index distribution having a circular symmetry.

More specifically, components used for manufacturing a refractive index distribution film include a glass substrate 12, 20, a transparent electrode 14, 18, 26, alignment layer 22, 24 and an insulating layer 16. Wherein, the components used for manufacturing the refractive index distribution film are disposed on the glass substrate 12, the transparent electrode 14, the insulating layer 16, the transparent electrode 18, the glass substrate 20, the alignment layer 22, the alignment layer 24, the transparent electrode 26 and the glass substrate 28 along the Z-direction. The mixture of a liquid crystal and a liquid crystalline polymer used for forming the refractive index distribution film 1 is disposed between the alignment layer 22 and the alignment layer 24. Wherein, the transparent electrode 18 is designed as a circular electrode layer; the transparent electrode 14, 20 is designed as a planar electrode structure; a first voltage V₁ is applied between the transparent electrodes 18 and 26, and a second voltage V₂ is applied between the transparent electrodes 14 and 26 to form a circular symmetric voltage distribution.

By controlling the magnitude of the first voltage V₁ and the second voltage V₂, the mixture of the liquid crystal and the liquid crystalline polymer in the refractive index distribution film 1 can be adjusted to form a circular symmetric refractive index distribution. Wherein, the glass substrate 12, 20, 28 of this preferred embodiment can be substituted by a material with high dielectric constant or high impedance.

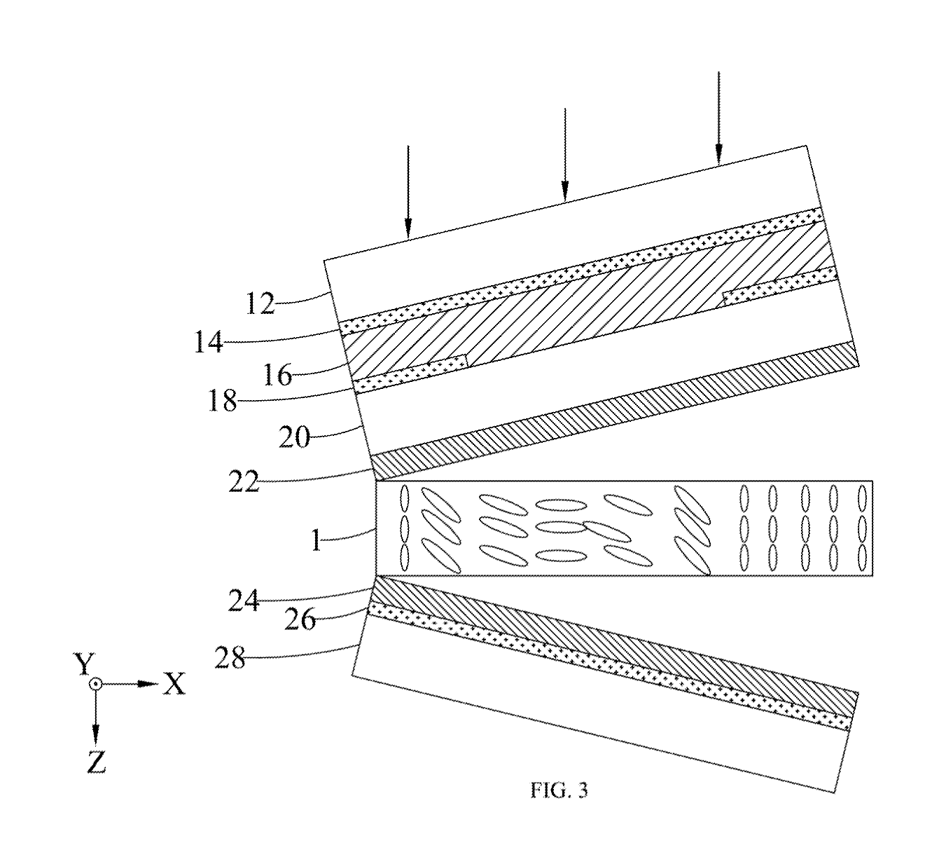

With reference to FIG. 3 for a second schematic view of a method of manufacturing a refractive index distribution film in accordance with an embodiment of the present invention, an ultraviolet (UV) light exposure can cure the mixture of the liquid crystal and liquid crystalline polymer, and the refractive index distribution film l undergoes a phase separation. In other words, the liquid crystal and polymer in the refractive index distribution film 1 are cured and peeled off the refractive index distribution film 1 from the components used for manufacturing the refractive index distribution film 1.

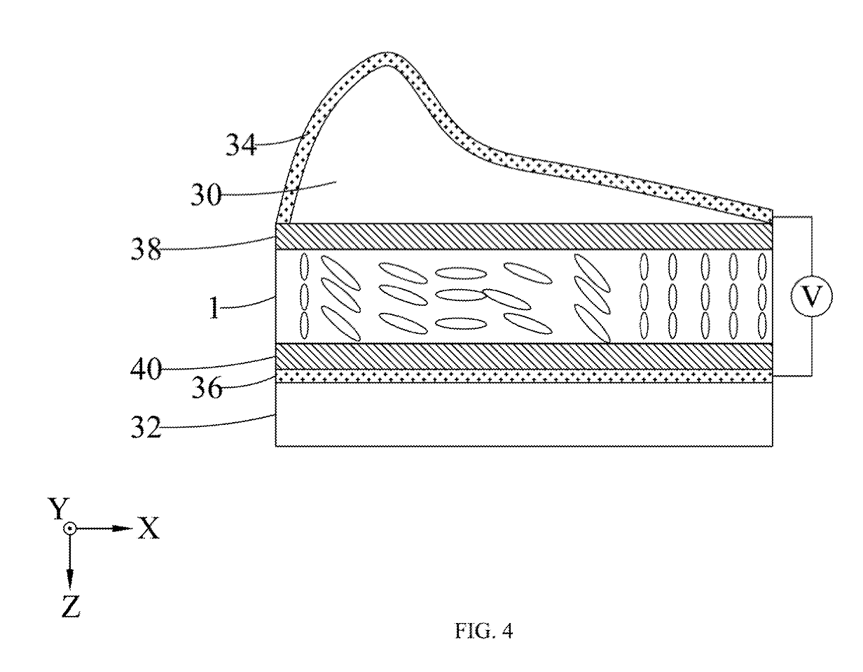

With reference to FIG. 4 for a first schematic view of a method of manufacturing a refractive index distribution film in accordance with another embodiment of the present invention, the difference between the manufacturing method of this embodiment and the manufacturing method as shown in FIG. 2 resides on this embodiment adopts a circular asymmetric glass substrate to achieve the non-uniform electric field for manufacturing the refractive index distribution film 1 with a non-uniform refractive index distribution.

More specifically, components used for manufacturing a refractive index distribution film include a glass substrate 30, 32, a transparent electrode 34, 36, and an alignment layer 38, 40. Wherein, the components used for manufacturing the refractive index distribution film are disposed along the Z-direction include a transparent electrode 34, a glass substrate 30, an alignment layer 38, an alignment layer 40, a transparent electrode 36 and a glass substrate 32, and a mixture of a liquid crystal and a liquid crystalline polymer used for forming the refractive index distribution film 1 is disposed between the alignment layer 38 and the alignment layer 40. In the present embodiment, a voltage V₃ is applied between the transparent electrode 34 and the transparent electrode 36, and the glass substrate 30 is designed thicker on a side and thinner on the other opposite side to achieve a non-uniform electric field distribution. In other words, the electric field at a position on the thicker side is smaller, and the electric field at a position on the thinner side is greater, so that a refractive index distribution film with a gradual refractive index distribution can be manufactured.

In addition to the aforementioned manufacturing method, another method of using a pixel electrode to drive a liquid crystal and a liquid crystalline polymer mixture at different positions in the refractive index distribution film 1 to manufacture a refractive index distribution film with a non-uniform refractive index distribution, such as the aforementioned refractive index distribution film with a gradual and symmetric refractive index distribution or the refractive index distribution film with any refractive index distribution.

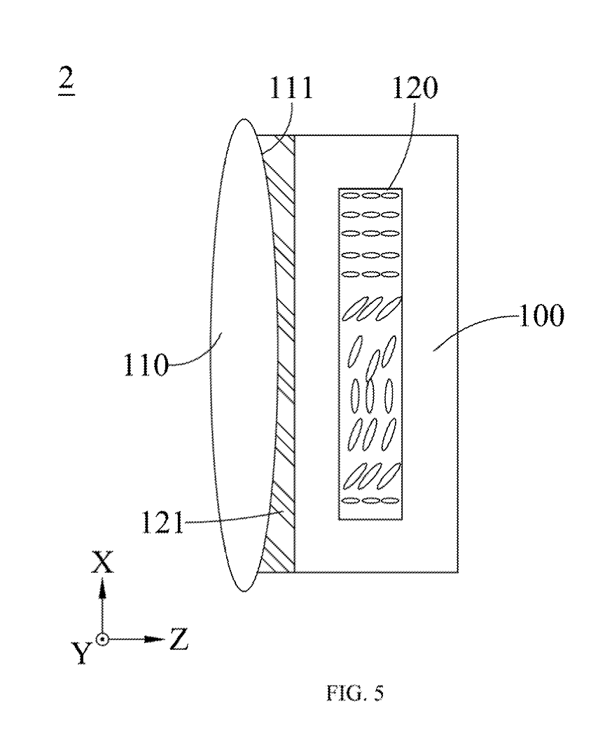

With reference to FIG. 5 for a second schematic view of a method of manufacturing a refractive index distribution film in accordance with a first embodiment of the present invention, the liquid crystalline polymer lens structure 2 comprises a flexible substrate 100, a first lens 110 and a first refractive index distribution film 120.

The first refractive index distribution film 120 composed of a liquid crystal and a liquid crystalline polymer having the feature of birefringence is manufactured by the aforementioned method and encapsulated inside a flexible substrate 100. The first refractive index distribution film 120 has a first refractive index in the X-direction and a second refractive index in the Y-direction.

The flexible substrate 100 is a laminating film or a flexible plastic substrate used for packaging the first refractive index distribution film 120. In the present embodiment, after the first refractive index distribution film is packaged inside the flexible substrate 100, and an adhesive 121 can be coated onto a side of the flexible substrate 100 and adhered with a first surface 111 of the first lens 110, so that the focal length of the first lens 110 can be adjusted. In industrial applications, the flexible substrate 100 encapsulated with the first refractive index distribution film 120 can be laminated onto a glasses lens for adjusting the power of the glasses.

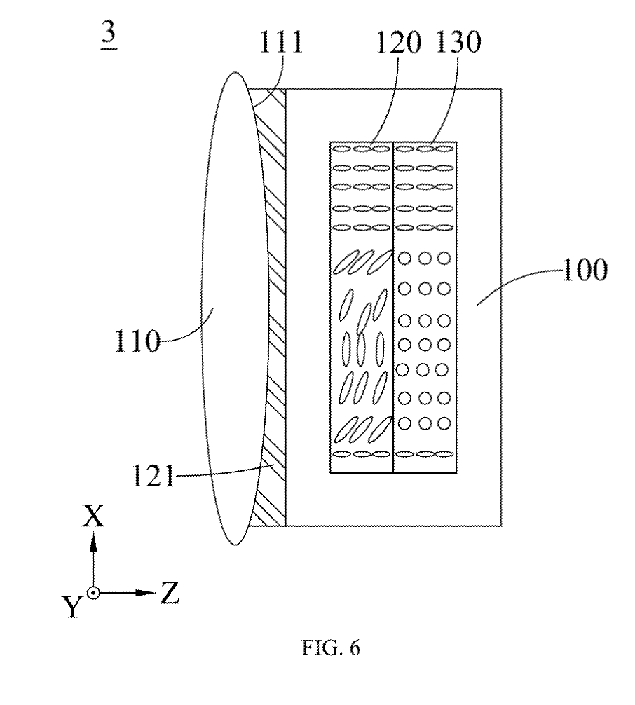

With reference to FIG. 6 for a schematic view of a liquid crystalline polymer lens structure in accordance with a second embodiment of the present invention, the difference between the liquid crystalline polymer lens structure 2 of the first embodiment and the liquid crystalline polymer lens structure 3 of the present embodiment resides on that the liquid crystalline polymer lens structure 3 further comprises a second refractive index distribution film 130 which is a mixture of a liquid crystal and a liquid crystalline polymer and encapsulated inside flexible substrate 100 according to the aforementioned method, so that the liquid crystalline polymer lens structure 3 has the feature of birefringence. The second refractive index distribution film 130 has a third refractive index in the X-direction and the fourth refractive index in the Y-direction.

In the present embodiment, the second refractive index distribution film 130 is encapsulated inside the flexible substrate 100, and the first refractive index distribution film 120 has an optical axis in the X-direction, and the second refractive index distribution film 130 has an optical axis in the Y-direction. Wherein, the flexible substrate 100 can be a laminating film or a flexible plastic film for encapsulating the first refractive index distribution film 120 and the second refractive index distribution film 130. With the two refractive index distribution films 120, 130 with their optical axes perpendicular to each other, the liquid crystalline polymer lens structure 3 of the present embodiment can achieve the expected effect without requiring the polarizer.

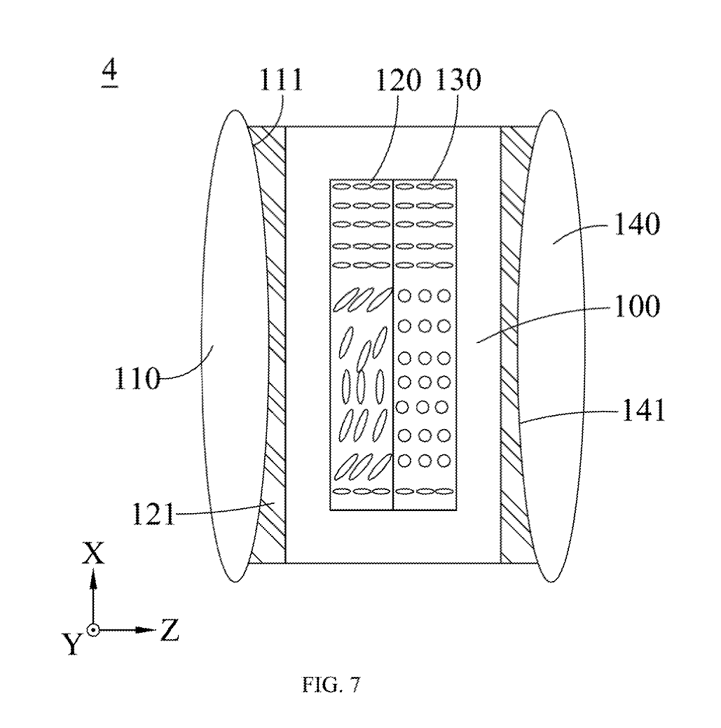

With reference to FIG. 7 for a schematic view of a liquid crystalline polymer lens structure in accordance with a third preferred embodiment of the present invention, the major difference between the liquid crystalline polymer lens structure 4 of this preferred embodiment and the liquid crystalline polymer lens structure 3 of the second preferred embodiment resides on that the liquid crystalline polymer lens structure 4 of this preferred embodiment further comprises a second lens 140, and the second lens 140 has a second surface 141 opposite to the first surface 111 of the first lens 110, and the flexible substrate 100 laminated between the first surface 111 and the second surface 141 by the adhesive 121.

It is noteworthy that each liquid crystalline polymer lens structure 2, 3, 4 of the first embodiment, the second embodiment and the third embodiment has the first refractive index and the second refractive index of the first refractive index distribution film 120 and the third refractive index and the fourth refractive index of the second refractive index distribution film 130 in the X- and Y-directions, and also has a circular symmetric optical power, a gradual optical power or any refractive index distribution. By adjusting the refractive index distribution of the refractive index distribution film in the X- and Y-directions, the focal length of the lens or the power of glasses can be adjusted.

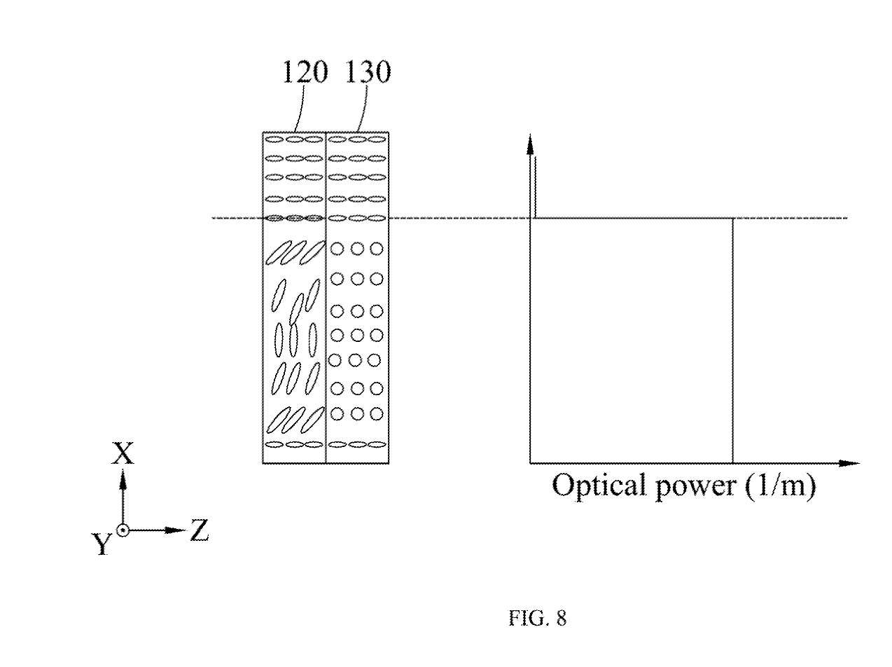

With reference to FIG. 8 for a first schematic view showing the lens effect of a liquid crystalline polymer lens structure in accordance with the third embodiment of the present invention, the refractive index distribution film manufactured according to the method as shown in FIG. 2 is used as an example. Since the liquid crystalline polymer molecules at the ends of the first refractive index distribution film 120 and the second refractive index distribution film 130 are erected, therefore the refractive index remains unchanged and there is no lens effect. Other parts of the first refractive index distribution film 120 and the second refractive index distribution film 130 have a single lens effect due to the distribution of the liquid crystal molecules.

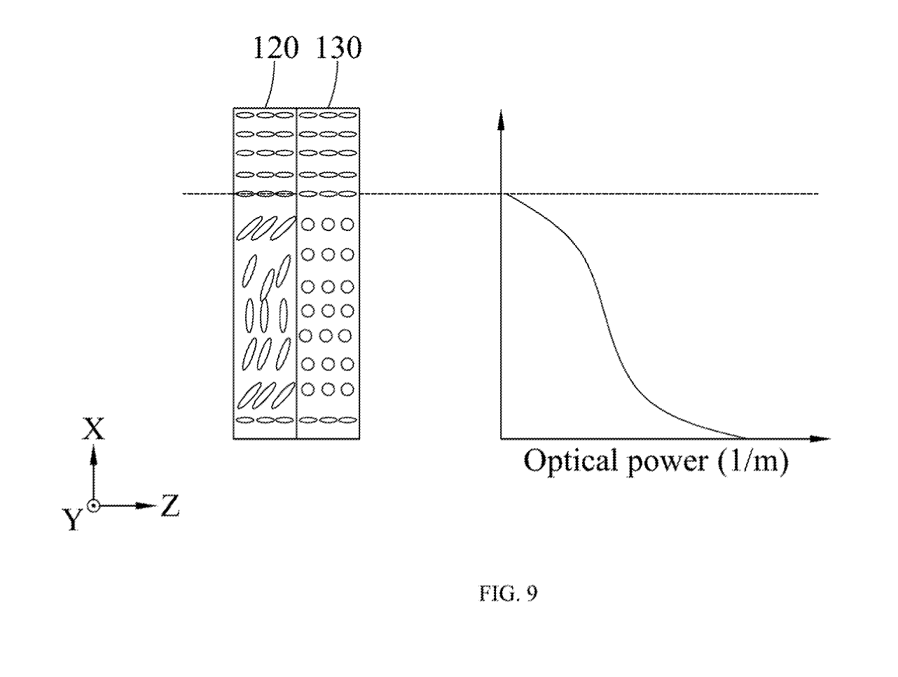

With reference to FIG. 9 for a second schematic view showing the lens effect of a liquid crystalline polymer lens structure in accordance with the third embodiment of the present invention, the refractive index distribution film manufactured according to the method as shown in FIG. 4 is used as an example. Since the liquid crystalline polymer molecules at the ends of the first refractive index distribution film 120 and the second refractive index distribution film 130 are erected, therefore the refractive index remains unchanged and there is no lens effect. The optical power is increasing gradually along the X-direction for providing additional optical power to improve the presbyopia's reading ability.

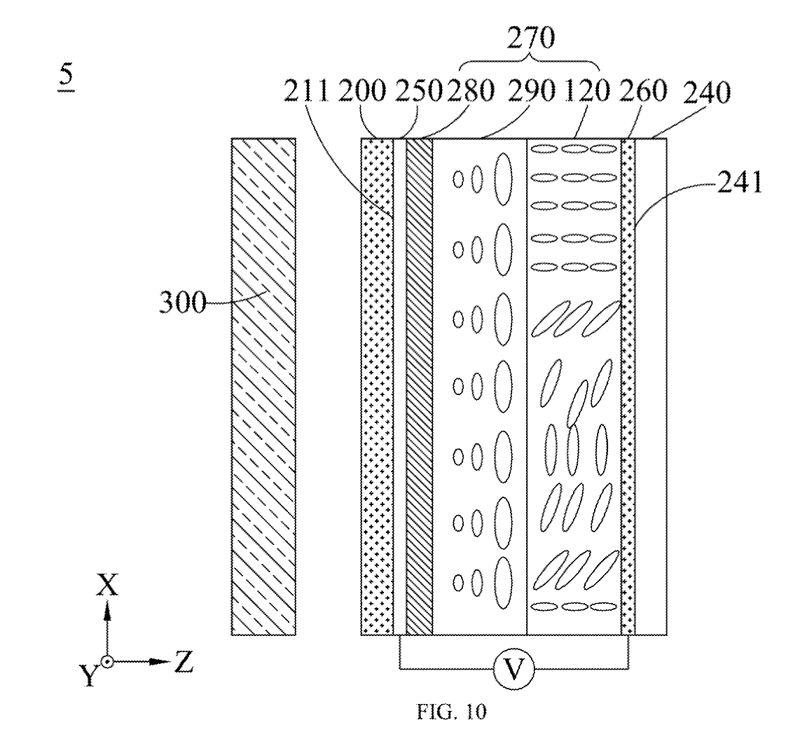

With reference to FIG. 10 for a schematic view of a liquid crystalline polymer lens structure in accordance with a fourth embodiment of the present invention, the liquid crystalline polymer lens structure 5 comprises a first lens 200, a second lens 240, a first electrode layer 250, a second electrode layer 260 and a composite layer 270. Wherein, the first lens 200 has a first surface 211, and the second lens 240 has a second surface 241 facing the first surface 211. The first electrode layer 250 is disposed on the first surface 211 of the first lens 200, and the second electrode layer 260 is disposed on the second surface 241 of the second lens 240. The composite layer 270 is disposed between the first electrode layer 250 and the second electrode layer 260, and the composite layer 270, arranged along the direction from the first electrode layer 250 to the second electrode layer 260 (which is the Z-direction), sequentially comprises a first alignment layer 280, a first liquid crystal layer 290 and a first refractive index distribution film 120.

Wherein, the first alignment layer 280 is disposed on the first electrode layer 250, and the first liquid crystal layer 290 is disposed on the first alignment layer 280, and the first refractive index distribution film 120 is disposed on the first liquid crystal layer 290. Wherein, the first refractive index distribution film is the refractive index distribution film 120 manufactured by the aforementioned method and composed of a liquid crystal and a macromolecular polymer, and the first refractive index distribution film has the feature of birefringence.

With the first liquid crystal layer 290 in the composite layer 270 as shown in the figure, if a voltage V is applied between the first electrode layer 250 and the second electrode layer 260, the arrangement of the liquid crystals in the first liquid crystal layer will be affected and rotated, so that the polarization direction of the incident light can be changed, and the focal length of the liquid crystalline polymer lens structure 5 can be changed. If an additional polarizer 300 is added at a position opposite to the first surface 211 of the first lens 200, the liquid crystalline polymer lens structure 5 can be used as a signal switch of the optical signal or applied in 3D display technologies.

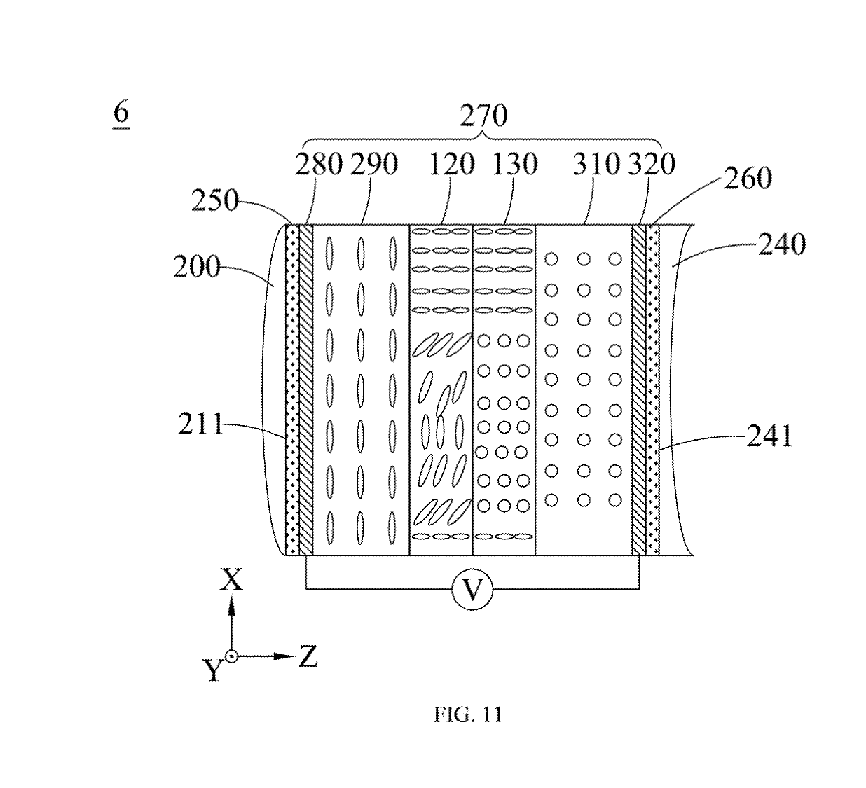

With reference to FIG. 11 for a schematic view of a liquid crystalline polymer lens structure in accordance with a fifth embodiment of the present invention, the composite layer 270 of the liquid crystalline polymer lens structure 6 along the Z-direction further comprises a second refractive index distribution film 130, a second liquid crystal layer 310 and a second alignment layer 320. Wherein, the second refractive index distribution film 130 is the refractive index distribution film 130 manufactured by the aforementioned method and composed of a liquid crystal and a macromolecular polymer, and the second refractive index distribution film 130 has the feature of birefringence.

The second liquid crystal layer 310 is disposed on the second refractive index distribution film 130, and the second alignment layer 320 is disposed on the second liquid crystal layer 310. Wherein, the alignment direction of the first liquid crystal layer 290 is different from the alignment direction of the second liquid crystal layer 310, and the alignment direction of the first refractive index distribution film 120 is different from the alignment direction of the second refractive index distribution film 130. Since the liquid crystalline polymer distribution film has a dielectric constant distribution and an ability of aligning liquid crystals, therefore this present embodiment with the design of the liquid crystal and the electrode layer can achieve the effect of a dynamic lens. For example, if no voltage is applied between the electrode layers in the present embodiment, the liquid crystalline polymer lens structure 6 will have a constant optical power. On the other hand, if a voltage is applied between the electrode layers, the liquid crystalline polymer lens structure 6 will have a continuous optical power distribution.

It is noteworthy that by adjusting the alignment directions of the first alignment layer 280 and the second alignment layer 320, the first liquid crystal layer 290 or the second liquid crystal layer 310 of the present embodiment can be aligned as an anti-parallel alignment, a vertical alignment, a hybrid alignment or a twisted nematic alignment.

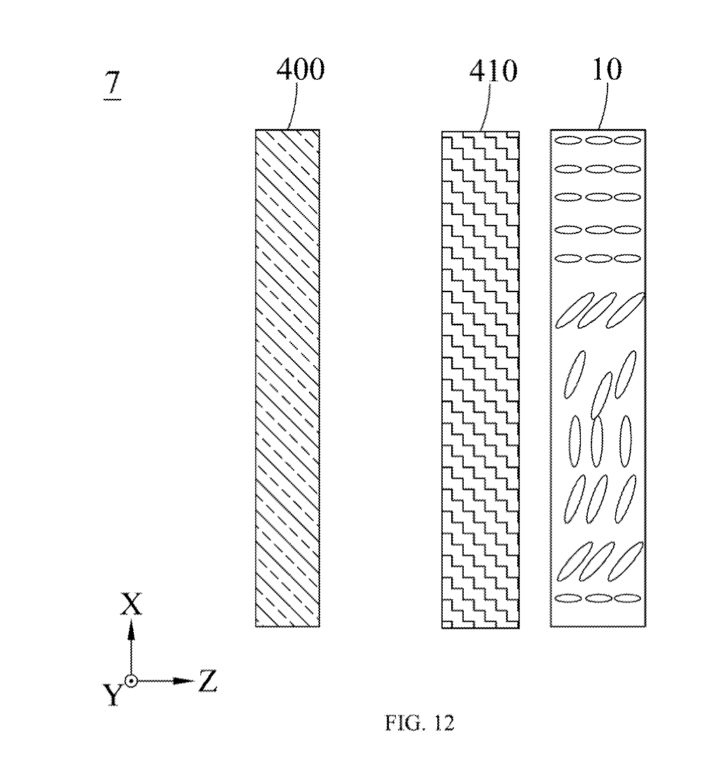

With reference to FIG. 12 for a schematic view of a liquid crystalline polymer lens structure in accordance with a sixth embodiment of the present invention, the liquid crystalline polymer lens structure 7 comprises a refractive index distribution film 10, a polarizer 400 and a polarization controller 410. The refractive index distribution film 10 is the refractive index distribution film 130 manufactured by the aforementioned method and composed of a liquid crystal and a liquid crystalline polymer, and the refractive index distribution film 10 has the feature of birefringence.

The polarizer 400 is installed on a side of the refractive index distribution film 10, and the polarization controller 410 is installed between the polarizer 400 and the refractive index distribution film 10. Wherein, the polarization controller 410 is used for changing the polarization direction of a polarized light passing through the polarizer 400 in order to change the focal length of the liquid crystalline polymer lens structure 7. For example, if the polarization controller 410 changes the polarization direction of the polarized light passing through the polarizer 400 from the X-direction to the Y-direction or vice versa, the liquid crystalline polymer lens structure 7 will have two different optical power distributions.

In summation of the description above, the liquid crystalline polymer lens structure has a refractive index distribution film with birefringence, which can be set as a lens with a gradual optical power or a symmetric optical power, and the refractive index distribution film can he encapsulated by a flexible substrate and laminated onto a glasses lens for changing the power of glasses or provide additional optical power for a presbyopia's reading ability. Therefore, the liquid crystalline polymer lens structure of the present invention can be applied onto various kinds of glasses lenses easily or laminated onto a solid lens to act as a simple and convenient lens sticker.

While the means of specific embodiments in present invention has been described by reference drawings, numerous modifications and variations could be made thereto by those skilled in the art without departing from the scope and spirit of the invention set forth in the claims.

What is claimed is:

1. A liquid crystalline polymer lens structure, comprising:
a flexible substrate;
a first lens, having the flexible substrate laminated on a first surface of the first lens; and
a first refractive index distribution film, composed of a liquid crystal and a liquid crystalline polymer, and encapsulated inside the flexible substrate, and the first refractive index distribution film having a first refractive index parallel to a first direction of the first surface, and a second refractive index parallel to a second direction of the first surface, and the first direction being different from the second direction, and the first refractive index and the second refractive index having a non-uniform refractive index distribution on the first direction and the second direction respectively.

2. The liquid crystalline polymer lens structure of claim 1, further comprising a second refractive index distribution film composed of a liquid crystal and a liquid crystalline polymer and encapsulated inside the flexible substrate, wherein the second refractive index distribution film has a third refractive index parallel to the first direction of the first surface and a fourth refractive index parallel to the second direction of the first surface, and the first refractive index distribution film has an optical axis in the first direction, and the second refractive index distribution film has an optical axis in the second direction.

3. The liquid crystalline polymer lens structure of claim 2, further comprising a second lens with a second surface opposite to the first surface, and the flexible substrate being laminated between the first surface and the second surface.

4. The liquid crystalline polymer lens structure of claim 2, wherein the third refractive index and the fourth refractive index have a non-uniform refractive index distribution in the first direction and the second direction respectively.

5. The liquid crystalline polymer lens structure of claim 1, wherein the flexible substrate is a laminating film or a flexible plastic substrate.

6. A liquid crystalline polymer lens structure, comprising:
a first lens, having a first surface;
a second lens, having a second surface facing the first surface;
a first electrode layer, disposed on the first surface of the first lens;
a second electrode layer, disposed on the second surface of the second lens; and
a composite layer, disposed between the first electrode layer and the second electrode layer, and the composite layer, in the direction from the first electrode layer to the second electrode layer, sequentially comprising:
a first alignment layer, disposed on the first electrode layer;
a first liquid crystal layer, disposed on the first alignment layer; and
a first refractive index distribution film, composed of a liquid crystal and a liquid crystalline polymer, and disposed on the first liquid crystal layer, and having a birefringence with a non-uniform refractive index distribution.

7. The liquid crystalline polymer lens structure of claim 6, wherein the composite layer, along the direction from the first electrode layer to the second electrode layer, sequentially comprises: a second refractive index distribution film composed of a liquid crystal and a liquid crystalline polymer and disposed on the first refractive index distribution film, and having a birefringence and a non-uniform refractive index distribution; a second liquid crystal layer, disposed on the second refractive index distribution film; and a second alignment layer, disposed on the second liquid crystal layer; wherein the first liquid crystal layer has an alignment direction different from the alignment direction of the second liquid crystal layer, and the first refractive index distribution film has an alignment direction different from the alignment direction of the second refractive index distribution film.

8. The liquid crystalline polymer lens structure of claim 6, further comprising a polarizer installed on the other side of the first surface of the first lens.

9. The liquid crystalline polymer lens structure of claim 8, wherein the first liquid crystal layer is aligned as an anti-parallel alignment, a vertical alignment, a hybrid alignment or a twisted nematic alignment.

10. A liquid crystalline polymer lens structure, comprising:
a refractive index distribution film, composed of a liquid crystal and a liquid crystalline polymer, and having a birefringence with a non-uniform refractive index distribution;
a polarizer, installed on a side of the refractive index distribution film; and
a polarization controller, installed between the polarizer and the refractive index distribution film;
wherein the polarization controller changes the polarization direction of a polarized light passing through the polarizer.
